(19) United States
(12) Patent Application Publication
(10) Pub. No.: US 2013/0048563 A1
(43) Pub. Date: Feb. 28, 2013

(54) TANNIN POLYMERS AS AIDS FOR REDUCING FOULING OF CERAMIC MEMBRANES

(71) Applicants: Abdul Rafi Khwaja, Trevose, PA (US); David M. Polizzotti, Yardley, PA (US); Carl Vess, Niskayuna, NY (US); Anthony Yu-Chung Ku, Niskayuna, NY (US)

(72) Inventors: Abdul Rafi Khwaja, Trevose, PA (US); David M. Polizzotti, Yardley, PA (US); Carl Vess, Niskayuna, NY (US); Anthony Yu-Chung Ku, Niskayuna, NY (US)

(73) Assignee: GENERAL ELECTRIC COMPANY, Schenectady, NY (US)

(21) Appl. No.: 13/221,149

(22) Filed: Aug. 30, 2011

(51) Int. Cl. B01D 65/08; C02F 1/68; C02F 1/66

(52) U.S. Cl. 210/639

(57) ABSTRACT

The present invention concerns a method of reducing fouling of ceramic membranes by adding an effective amount of a tannin polymer to SAGD process water. Additionally, a cationic and/or an anionic flocculant can also be added to treat the process water. Once the process water is treated, the solids are then separated out and the resulting clean process water is then passed through a ceramic membrane. Typically, the tannin polymer used in treating the process water is comprised of a Mannich reaction product of an amine, an aldehyde, and a tannin. The components are reacted at an acidic pH wherein the molar ratio of amine to tannin present is from about 1.5:1-3.0:1. Exemplary tannin/amine/formaldehyde compounds include tannin/melamine/formaldehyde polymers, and tannin/monoethanolamine/formaldehyde polymers.

### BACKGROUND OF THE INVENTION

1. Field of the Invention

This invention is related to a method of filtering steam assisted gravity drainage (SAGD) process waters obtained from oil recovery operations. More particularly, the invention relates to a process of reducing fouling of ceramic membranes by treating SAGD process waters with tannin polymers.

2. Description of Related Art

Steam assisted gravity drainage (SAGD) methods are commonly employed as an enhanced oil recovery technique for producing heavy crude oil and bitumen, especially in the oil sands projects. In this method, two parallel horizontal wells are drilled. The upper well injects steam into the geological formation, and the lower well collects the heated crude oil or bitumen that flows out of the formation along with water from the condensation of the injected steam. This condensed steam and oil are pumped to the surface wherein the oil is separated, leaving an oily/water mixture known as “produce(d) water”. Roughly three barrels of this oily and bituminous containing process water are produced per barrel of recovered oil. Recovery and reuse of the water are needed to reduce operational costs and to minimize environmental concerns.

The process water is eventually recycled to the steam generators used in the SAGD process, but it must first be clarified and separated from substantial amounts of suspended and emulsified oil, bitumen and other impurities like salts, silica, etc. The SAGD process water normally contains about 1-60% solids and has a temperature of about 95° C. Typically, filtering of the SAGD process water occurs through a ceramic membrane. However, as the SAGD process water contains substantial amounts of suspended and emulsified oil, bitumen and other impurities, fouling of the ceramic membranes frequently occurs. It has accordingly been difficult to provide for effective clarification of this SAGD process water.

The current invention provides for a method of reducing fouling of ceramic membranes by treating SAGD process waters with tannin polymers before passing the process water through a ceramic membrane. Tannin based polymer treated process water exhibited less fouling tendency compared to non-tannin based polymer treated water.

### SUMMARY OF THE INVENTION

The present invention concerns a method of reducing fouling of ceramic membranes by adding an effective amount of a tannin polymer to SAGD process water. Additionally, a cationic and/or anionic flocculant can also be added to treat the process water. The solids are then separated out of the process water and the resulting clean process water is then run through a ceramic membrane.

Typically, the tannin polymer is comprised of a Mannich reaction product of an amine, an aldehyde, and a tannin. The amine, aldehyde, and tannin can be combined simultaneously, or in different orders. The components are reacted at an acidic pH wherein the molar ratio of amine to tannin present is from about 1.5:1-3.0:1. Exemplary tannin/amine/formaldehyde compounds include tannin/melamine/formaldehyde polymers, and tannin/monoethanolamine/formaldehyde polymers. Compounds according to the present convention are being sold by GE under the designation Klaraid PC 2700.

The present invention and its advantages over the prior art will become apparent upon reading the following detailed description and the appended claims.

### BRIEF DESCRIPTION OF THE DRAWINGS

These and other aspects of the invention will be understood from the description and claims herein, taken together with the drawings showing details of construction and illustrative embodiments, wherein:

FIG. 1 depicts the microstructure of deposits for the compressed untreated process water on a ceramic membrane;

FIG. 2 depicts the microstructure of deposits for the compressed process water treated with the tannin polymer on a ceramic membrane;

FIG. 3 depicts a plot of the weight of the untreated process water vs. time; and

FIG. 4 depicts a plot of the weight of the process water treated with the tannin polymer vs. time.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

In one embodiment of the invention, environmentally benign coagulants made from natural products such as tannins, are used to treat oil containing produce waters from tar sand SAGD operations. In another embodiment, the natural product coagulant may be conjointly employed with a cationic and/or anionic flocculants to treat the oily water. The solids are then separated out and the resulting, clean process water is then run through a ceramic membrane.

In one aspect of the invention, the oil containing produce water is adjusted to a pH range of between about 1 to 6, preferably between 2 and 5 and more preferably to a pH of about 4. Then, a tannin based polymer is added to the water in a dosage range of from about 1 to about 1000 ppm, preferably between 1 and 700 ppm and more preferably between 5 and 25 ppm. The water is then allowed to react for about 15 to 90 seconds. A cationic flocculant is added in a dosage range of 1 to 100 ppm, more preferably from about 5 to 20 ppm. The cationic flocculant is allowed to react for 2 to 40 seconds. Subsequent to the addition of the cationic flocculant, in another exemplary embodiment, an anionic flocculant is added in a dosage range of 1 to 100 ppm, more preferably from about 3 to 10 ppm. The anionic flocculant is allowed to react for 0 to 30 seconds, and the water phase is allowed to separate from the oil phase. The solids are then separated out and the resulting, clean process water is then run through a ceramic membrane, or any other suitable membrane as is known in the art without affecting the overall concept of the invention. The tannin based polymer treated water reduces fouling of the ceramic membrane by acting as a fouling reducing filtering aid.

In another embodiment, the tannin-based polymer can be directly injected into untreated SAGD process water. The tannin polymer containing SAGD process water reduces fouling of a ceramic membrane by acting as a fouling reducing filtering aid.

The tannin component can be obtained from various wood and vegetation materials found throughout the world. Tannins are a large group of water-soluble complex organic compounds that naturally occur in leaves, twigs, barks, wood, and fruit of many plants and are generally obtained by extraction from plant matter. The composition and structure of tannins will vary depending on the source and method of extraction, but the generic empirical formula is represented by C₇₆H₅₂O₄₆. Examples of barks from which tannins can be derived are wattle, mangrove, oak, eucalyptus, hemlock, pine, larch, and willow. Examples of woods are the quebracho, chestnut, oak, mimosa, and urunday. Examples of fruits are myrobalans, valonia, divi-diva, tara, and algarrobilla. Examples of leaves are sumac and gambier. Examples of roots are canaigre and palmetto.

These natural tannins can be categorized into the traditional “hydrolyzable” tannins and “condensed tannins” as disclosed by A. Pizzi in “Condensed Tannins for Adhesives”, Ind. Eng. Chem. Prod. Res. Dev. 1982, 21, 359-369. Condensed tannin extracts are those manufactured from the bark of the black wattle tree (or mimosa tannin of commerce), from the wood of the quebracho tree (Spanish: quebra hacha, axe-breaker,) from the bark of the hemlock tree, and from the bark of several commonly used pine species. The preparation of wattle and quebracho extracts is a well established industrial practice and they are freely available in considerable amounts.

Condensed tannin extracts, such as wattle and quebracho, are composed of approximately 70% polyphenolic tannins, 20% to 25% non-tannins, mainly simple sugars and polymeric carbohydrates (hydrocolloid gums), the latter of which constitute 3% to 6% of the extract and heavily contribute to extract viscosity, while the balance is accounted for by a low percentage of moisture. Although the exact structure is not known, it is believed that the main polyphenolic pattern in quebracho tannins is represented by flavonoid analogues based on resorcinol A and pyrogallol B rings as shown in Formula I below:

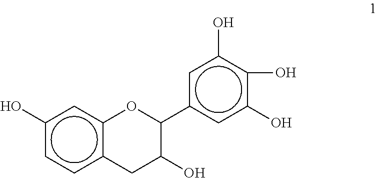

The second component is an aldehyde. Examples of preferred materials are formaldehyde which can be used in the form of a 37% active formaldehyde solution. This is also commercially available as formalin which is an aqueous solution of 37% formaldehyde which has been stabilized with from 6-15% methanol. Other commercial grades of formaldehyde and its polymers could be used. Such commercial grades include 44, 45 and 50% low-methanol, formaldehyde, solutions of formaldehyde in methyl, propyl, n-butyl, and isobutyl alcohol, paraformaldehyde and trioxane. When using solid paraformaldehyde, care must be taken that it all dissolves.

The third component for the reaction products is an amino compound such as ammonia or a primary or secondary amine or amide compound. Preferred materials include primary amines such as monoethanolamine, methylamine and ethylamine. The primary amines are preferred since they are the more reactive amines than secondary or tertiary amines. In reacting these three components it is necessary to do this under very controlled conditions and especially under a slight acidic condition where the pH is less than 7. Any acid can be used to obtain this condition and especially preferred are muriatic acid and acetic acid.

In one aspect of the invention, the tannin compound in accordance with the invention is a Mannich reaction product of an amine, an aldehyde, and a tannin, as set forth in U.S. Pat. No. 4,558,080, incorporated by reference herein in its entirety. As is stated in this patent, the amine, aldehyde, and tannin can be combined simultaneously, or in different orders. The components are reacted at an acidic pH wherein the molar ratio of amine, such as one having primary amine functionality, to tannin present is from about 1.5:1-3.0:1. Exemplary tannin/amine/formaldehyde compounds include tannin/melamine/formaldehyde polymers, and tannin/monoethanolamine/formaldehyde polymers. Compounds according to the present convention are being sold by GE under the designation Klaraid PC 2700.

The modified tannin compound in this composition has an environmentally friendly profile, namely, it has minimal toxicity to mammalian as well as aqueous organisms and it's biodegradable so that it results in minimal harmful effect to the environment after discharge.

The modified tannin as a product Mannich reaction of a tannin, an amine, and an aldehyde, does not significantly foam in application, therefore, in accordance with one aspect of the invention, none or substantially no antifoaming agents are needed.

In another embodiment of the present invention, the water soluble or dispersible tannin containing polymer composition comprises a polymer of tannin; a cationic monomer and an optional monomer selected from the group consisting of an anionic monomer and a nonionic monomer. These tannin polymers are described in U.S. Pat. No. 5,916,991 incorporated by reference herein in its entirety. As stated in the '991 U.S. patent, the cationic monomer is selected from a group containing ethylenically unsaturated quaternary ammonium, phosphonium or sulfonium ions. Typical cationic monomers are quaternary ammonium salts of dialkylaminoalkyl(meth) acrylamides, dialkylaminoalkyl(meth)acrylates and diallyldialkyl ammonium chloride.

Another tannin that can be used is a tannin based polymeric coagulant which is comprised of N,N-(dimethylaminoethyl)methacrylate (MADAME) polymerized using t-butylhydroperoxide and sodium metabisulfite. The resulting polyMADAME is converted to hydrochloride and then blended/reacted in an aqueous medium with tannin to obtain a homogenous poly(MADAME)-tannin composition. The mole ration of tannin/MADAME is about 1:0.5 to 1:50, with a preferred mole ratio of 1:1.5 to about 1:3. Molecular weight is from about 500 to about 2,000,000, preferably 5,000-200,000. One such tannin is sold by GE under the trademark “Coag 250”.

Another exemplary tannin is comprised of monomer [2-(methacryloyloxy)ethyl]triammonium chloride (METAC) polymerized using t-butylhydroperoxide and sodium metabisulfite. The resulting polyMETAC is then blended/reacted in an aqueous medium to obtain a homogenous poly(METAC)-tannin composition. The mole ration of tannin/METAC is from about 1:0.5 to about 1:5.0 with a preferred mole ration of 1:1.5 to about 1:3. Molecular weight of the polyMETAC is from about 500 to about 2,000,000 with a preferred molecular weight of about 5,000 to about 200,000.

Further examples of tannins can be found in U.S. Pat. No. 5,684,109 and U.S. Patent Application No. 2008/0149569, both are incorporated by reference herein in their entirety.

In another embodiment, the tannin based polymer, and mixtures thereof, may be conjointly employed with cationic and/or anionic flocculants to treat the oily water. The solids are then separated out and the resulting clean process water is run through a ceramic membrane. Exemplary cationic flocculants include the cationic acrylamide/quaternary ammonium salt copolymers, acrylamide/AETAC copolymer, polyEPI/DMA, acrylamide/allyl trialkyl ammonium copolymer, or an acrylamide diallyldialkyl ammonium copolymer.

The exemplary anionic flocculants comprise primarily acrylamide copolymers such as acrylamide/acrylic acid copolymers, acrylamide alkylacrylate copolymer, acrylamide/maleic acid, acrylamide maleic anhydride copolymers, and acrylamide/2-acrylamido-2-methyl propane sulfonic acid (AMPS). Additionally, acrylic acid homopolymers and salt forms, especially Na salts may be used along with acrylic acid based copolymers such as acrylic acid/AMPS copolymers. Specifically, the acrylic acid (AA)/acrylamide copolymers wherein the AA is present in an amount of about 20-50 molar %.

In operation when employing a SAGD method, two parallel horizontal wells are drilled. The upper well injects steam into the geological formation, and the lower well collects the heated crude oil or bitumen that flows out of the formation along with water from the condensation of the injected steam. This condensed steam and oil are pumped to the surface wherein the oil is separated, leaving an oil/water mixture, or process water. The process water is then clarified and separated from substantial amounts of suspended and emulsified oil, bitumen and other impurities like salts, silica, etc. by being passed through a ceramic membrane. The process water is compressed and pushed through the ceramic membrane as a compressive mass. Before the process water is pushed through the ceramic membrane, the process water is adjusted to a pH of between about 1 to 6, preferably to a pH of about 4. Then an effective amount of a tannin polymer is added to the process water. The tannin polymer is added to the process water in a dosage range of from 1 to 1000 ppm, preferably between 1 and 700 ppm, and more preferably between 5 and 25 ppm. Then, an effective amount of a cationic flocculant is added to the process water in a dosage range of from about 1 to 100 ppm, more preferably from about 5 to 20 ppm. Finally, an effective amount of an anionic flocculant is added to the process water in a dosage range of from about 1 to 100 ppm, more preferably from about 3 to 10 ppm. The solids from the process water then combine together and are separated out, and the treated process water is run through a ceramic membrane.

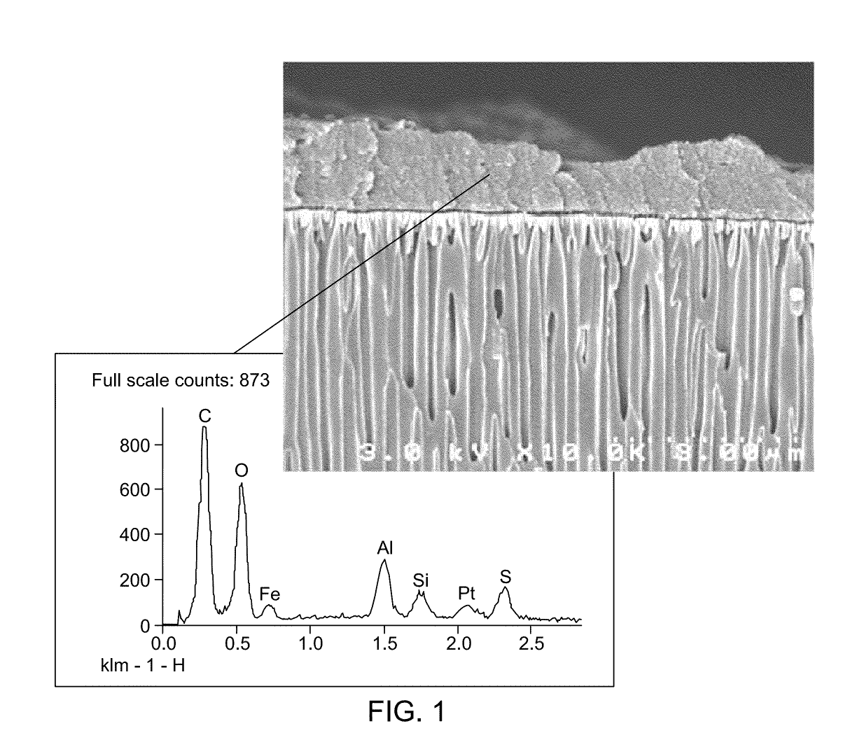

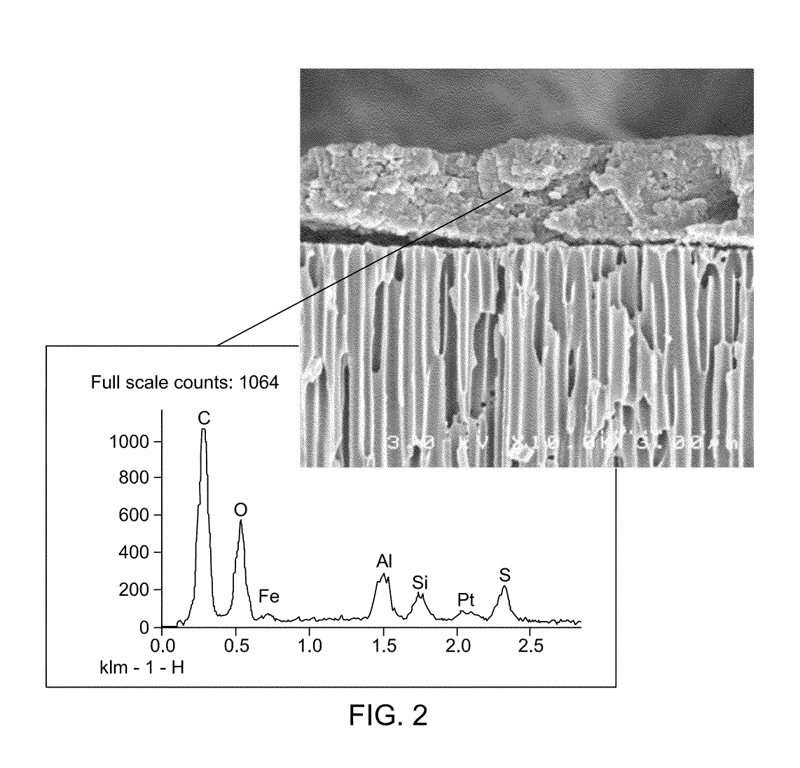

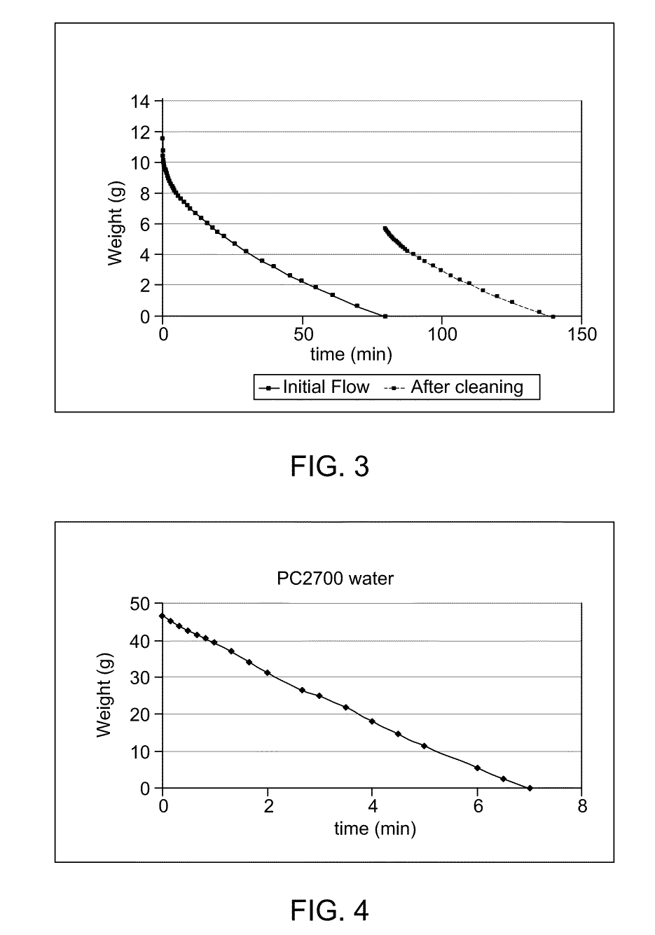

FIG. 1 discloses the microstructure of deposits for the compressed untreated process water on a ceramic membrane and FIG. 2 discloses the microstructure of deposits for the compressed process water treated with the tannin polymer on a ceramic membrane. As is shown in the figures, the untreated process water is more compressed than the process water treated with the tannin polymer, causing the untreated process water to foul the ceramic membrane. Further, FIG. 3 discloses the results of the untreated process water being passed through a ceramic membrane. The graph discloses the initial flow which results in fouling of the membrane, then the graph discloses the flow after cleaning of the membrane. Whereas, FIG. 4 discloses the results of the process water treated with the tannin polymer. The graph discloses that the treated process water reduces fouling rate of the ceramic membrane by about an order of magnitude, as opposed to the untreated process water as shown in FIG. 3

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A method of reducing fouling of ceramic membranes comprising:
adding an effective amount of a tannin containing polymer to process water; and
passing the tannin treated process water through a ceramic membrane.

2. The method of claim 1, wherein the tannin containing polymer is comprised of a Mannich reaction product of an amine, an aldehyde, and a tannin.

3. The method of claim 2, wherein the tannin containing polymer comprises tannin, amine, and formaldehyde containing co-polymers.

4. The method of claim 2, wherein the tannin containing polymer comprises tannin, melamine, and formaldehyde containing co-polymers.

5. The method of claim 2, wherein the tannin containing polymer comprises tannin, monoethanolamine, and formaldehyde containing co-polymers.

6. The method of claim 2, wherein molar ratio of amine to tannin is from about 1.5:1-3.0:1.

7. The method of claim 1, wherein the effective amount of tannin containing polymer is from about 1 to 700 ppm.

8. The method of claim 1, further comprising adjusting the process water to a pH of 2-6.

9. The method of claim 1, further comprising adding an effective amount of a cationic flocculant.

10. The method of claim 9, wherein the cationic flocculant is at least one component selected from the group consisting of cationic acrylamide/quaternary ammonium salt copolymers, acrylamide/AETAC copolymer, polyEPI/DMA, acrylamide/allyl trialkyl ammonium copolymer, and an acrylamide diallyldialkyl ammonium copolymer.

11. The method of claim 9, wherein the effective amount of the cationic flocculant is from about 1 to 100 ppm.

12. The method of claim 1, further comprising adding an effective amount of an anionic flocculant.

13. The method of claim 12, wherein the anionic flocculant is at least one component selected from the group consisting of acrylamide copolymers such as acrylamide/acrylic acid copolymers, acrylamide alkylacrylate copolymer, acrylamide/maleic acid, acrylamide maleic anhydride copolymers, and acrylamide/2-acrylamido-2-methyl propane sulfonic acid (AMPS).

14. The method of claim 12, wherein the effective amount of the anionic flocculant is from about 1 to 100 ppm.

15. A method of reducing fouling comprising:
adjusting pH of process water to 4;
adding an effective amount of tannin containing polymer to the process water; and
passing process water through a membrane.

16. The method of claim 15, wherein the membrane is a ceramic membrane.

17. The method of claim 15, wherein the tannin containing polymer is a polymer of tannin and a cationic monomer.

18. The method of claim 17, wherein the cationic monomer is at least one component selected from the group consisting of quaternary ammonium salts of dialkylaminoalkyl(meth) acrylamides, dialkylaminoalkyl(meth)acrylates and diallyldialkyl ammonium chloride.

19. The method of claim 17, wherein the tannin containing polymer further comprises a component selected from the group consisting of an anionic monomer and a nonionic monomer.

20. The method of claim 15, further comprising adding an effective amount of a cationic flocculant and an anionic flocculant.
